(19) United States
(12) Patent Application Publication
(10) Pub. No.: US 2005/0148296 A1
(43) Pub. Date: Jul. 7, 2005

(54) Media system, user terminal and method of providing content items relating to broadcast media stream

(76) Inventors: Toni Kopra, Vantaa (FI); Mikko Makipaa, Helsinki (FI); Akseli Anttila, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/511,815

(22) PCT Filed: Apr. 14, 2003
(86) PCT No.: PCT/FI03/00289

(30) Foreign Application Priority Data
Apr. 22, 2002 (US) 10126623
Jul. 1, 2002 (IB) IB0202537
Dec. 16, 2002 (US) 10319475

(51) Int. Cl. H04B 7/00

(52) U.S. Cl. 455/3.01; 455/414.1; 455/186.1; 455/45

(57) ABSTRACT

The invention relates to a media system, a user terminal and a method of providing one or more content items to at least one user terminal, the content item being related to a broadcast media stream. The method comprises: attaching the content item to a broadcasting time line of the broadcast media stream by a broadcasting system; broadcasting the broadcast media stream by the broadcasting system; synchronizing an internal time of the user terminal with the internal time of the broadcasting system; sending the content item attached to the broadcasting time line from the radio system to the user terminal; and presenting the received content item in the user terminal at a given moment in time that is based on the attachment and on the synchronization.

### FIELD

The invention relates to a method of providing content items to user terminals of a radio system, the content items relating to a broadcast media stream, a media system and a user terminal of a radio system.

### BACKGROUND

Broadcasters, such as television and radio, have taken steps to provide the audience with digital supplementary services, such as program information, news, weather reports, competitions and the like, in addition to the traditional media stream. The digital supplementary services are usually delivered to the audience over the Internet using the audiences' personal computers or other devices capable of connecting to the Internet. Radio and television stations, for example, are eager to deliver the contents of the content provider's through their service and to obtain revenues from content sales. For example, ringing tones and logos are offered on the content provider's web sites and are delivered to the users from the content provider's system. The users are, however, required to take up the task of navigating to the web sites to access the information on what kind of contents are available and how to acquire or purchase those. The content providers, in turn, have to promote the web address in the broadcasting media, for example, to attract users to visit the web site.

More mobility for the audience is provided by user terminals in cellular telecommunication systems, which user terminals are equipped with a radio receiver, such as an FM radio, for receiving media streams broadcast by radio broadcasters. Radio broadcasters typically provide Internet services, which can be accessed by a user terminal, such as one equipped with a WAP (Wireless Application Protocol), capable of connecting to such a service. It is also typical that complex instructions on how to use different SMS (Short Message Service) based mobile services are provided in particular Internet sites. In order to obtain a service needed, the user is required to navigate to the broadcaster's Internet site and select the correct service. In order to inform the users about the services available, the broadcasters usually promote their Internet address in actual radio broadcasts or in another mass media.

There are, however, problems related to the complexity when a user needs to access a service. The complexity arises from a need to advertise service addresses by the broadcasters and to memorize desired service addresses by the user. Furthermore, navigating a way through a complicated Internet web structure to the correct service address is laborious and time consuming. Acquiring a ringing tone, for example, requires the user to send a text message to a defined service number using a service code and a content identification string. The service codes and identification strings are often difficult to remember. Especially in a radio broadcast, it is almost impossible to communicate the required code and identification for a particular content offered to the audience. The complexity concerning accessing services results in difficulties to connect users to a service and low ratings of the service.

### BRIEF DESCRIPTION OF THE INVENTION

An object of the invention is to provide an improved method of providing content items to user terminals of a radio system and an improved media system. According to an aspect of the invention, there is provided a method of providing one or more content items to at least one user terminal of a radio system, the content item being related to a broadcast media stream. The method comprises: attaching the content item to a broadcasting time line of the broadcast media stream by a broadcasting system; broadcasting the broadcast media stream by a broadcasting system; synchronizing an internal time of the user terminal with the internal time of the broadcasting system; sending the content item attached to the broadcasting time line of the broadcast media stream from the radio system to the user terminal; and presenting the received content item in the user terminal at a given moment in time that is determined based on the attachment of the content item to the broadcasting time line and on the synchronization of the internal time of the user terminal with the internal time of the broadcasting system.

According to another aspect of the invention, there is provided a media system comprising: a broadcasting system configured to broadcast a broadcast media stream. The media system further comprises: a radio system communicating with the broadcasting system and one or more user terminals, the broadcasting system is further configured to attach one or more content items to a broadcasting time line of the broadcast media stream in the broadcasting system; the user terminal is configured to synchronize an internal time of the user terminal with the internal time of the broadcasting system; the radio system is configured to send the content item attached to the broadcasting time line of the broadcast media stream to the user terminal; and the user terminal is further configured to present the received content item in the user terminal at a given moment in time that is determined based on the attachment of the content item to the broadcasting time line and on the synchronization of the internal time of the user terminal with the internal time of the broadcasting system.

According to another aspect of the invention, there is provided a user terminal of a radio system. The user terminal is configured to: synchronize the internal time of the user terminal with the internal time of the broadcasting system; receive one or more content items through the radio system which content items are attached to a broadcast media stream of the broadcasting system; and present the received content items attached to the broadcast media stream at a given moment in time that is determined based on the synchronization of the internal time of the user terminal with the internal time of the broadcasting system.

Preferred embodiments of the invention are described in the dependent claims.

The method and system of the invention provide several advantages. Viewing additional information related to the current media content is simple and easy. The users don't have to navigate through vast content structures to find the currently relevant content or to remember any addresses in order to view the currently interesting information relating to a broadcast media stream.

### LIST OF DRAWINGS

In the following, the invention will be described in greater detail with reference to the preferred embodiments and the accompanying drawings, in which

FIG. 1 shows an example of a structure of a radio system;

FIG. 2 shows an example of a structure of a media system;

FIG. 3 shows another example of a structure of a media system;

FIG. 4 shows an example of a structure of a user terminal;

FIG. 5 shows an example of time lines of a media system; and

FIG. 6 shows an example of a method of providing content items to a user terminal of a radio system.

### DESCRIPTION OF EMBODIMENTS

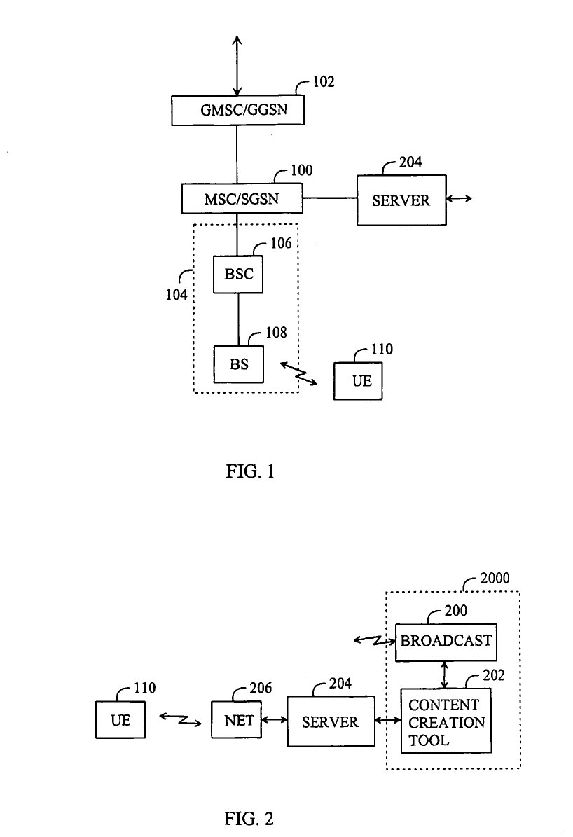

Let us first study FIG. 1 illustrating the structure of a radio system although it is assumed to be known per se. The radio system can be based on, for example, UMTS (Universal Mobile Telephone System) or WCDMA (Wideband Code Division Multiple Access).

The core network may correspond to the combined structure of the GSM (Global System for Mobile Communications) and GPRS (General Packet Radio Service) systems, for example. The GSM network elements are responsible for the implementation of circuit-switched connections, and the GPRS network elements are responsible for the implementation of packet-switched connections, some of the network elements, however, being shared by both systems.

A centre 100 represents a mobile services switching centre (MSC) and a serving GPRS support node (SGSN) that enable circuit-switched and packet switched signalling, respectively, in the radio system. Because the centre 100 can control all the traffic in the radio system, the centre 100 can gather accounting information of each user, which accounting information may be used in billing.

A core network may comprise a gateway unit 102, which is represented by a gateway mobile service switching centre (GMSC) and a gateway GPRS support node (GGSN). The GMSC attends to the circuit-switched connections between the core network and external networks, such as a public land mobile network (PLMN) or a public switched telephone network (PSTN), and the GGSN attends to the packet-switched connections between the core network and external networks such as the Internet.

The centre 100 controls a radio access network (RAN) 104, which may comprise at least one base station controller 106 controlling at least one base station 108. The base station controller 106 can also be called a radio network controller, and the base station 108 can be called node B. User terminal 110, such as a mobile phone, communicates with at least one base station 108 over a radio interface.

A server 204, which is an important part of the present solution, may be connected to the centre 100, but it may also be connected to the gateway 102 or to some part of the RAN 104. In some applications, the server 112 may communicate with the radio system over a radio interface in the same manner as the user terminal 110.

The present solution is generally described in FIG. 2. A media system comprises the following elements: a broadcasting system 2000 comprising a broadcast transmitting system 200 and a content creation tool 202, a server 204, a network 206 of the radio system and a user terminal 110.

The broadcast transmitting system 200, such as a radio station, transmits a broadcast media stream. The broadcast media stream is, for example, a radio program. In addition to the broadcast channel, the present solution also provides a parallel channel, which utilizes the content creation tool 202 and the radio system in the following way. The content creation tool 202 is configured to associate content items to a broadcasting time line of the broadcast media stream. The content item is related to the broadcasted media stream and can be a text, a picture, a widget (such as an on-screen button), a video, an audio recording, a game or a reference to download a game, a logo, a screen saver, a ringing tone, a multimedia presentation, a vibration/flashing/backlight/beeping tone sound of the user terminal, and a link to a video, a game, a screen saver, a ringing tone or a multimedia presentation, and a series of these or any combination thereof.

An internal time of the user terminal 110 is synchronized with the internal time of the broadcasting system 2000 in order to enable the use of the parallel channel. Using a synchronization algorithm in the user terminal 100, for example, may perform the synchronization. Thus, the user terminal 110 sends requests to the radio system 206 and performs calculations based on which the internal time of the user terminal 110 may be synchronized.

In an embodiment of the invention, synchronization data may first be sent to the user terminal 110 in order to enable the use of the parallel channel. The synchronization data is used for synchronizing an internal time of the user terminal 110 with the internal time of the broadcast system 2000. The synchronizing data can be sent to the user terminal 110 with the broadcast media stream broadcasted by the broadcasting system 2000, for example. Thus, the broadcasting system 2000 is configured to use a Radio Data System (RDS) known per se, for example, for sending the synchronization data. The synchronization data can be sent from the radio system 206 as well. Thus, the internal time of the radio system is synchronized with the internal time of the broadcast system before the synchronization data is sent to the user terminal 110. Under the control of the broadcast transmission system 200, the content creation tool 202 outputs a signal with one or more content items. The content item may comprise, for example, an object identification relating to the broadcast media stream, data about the music played at the moment, a time table of the program, news, quizzes, polls, comments forms, purchasing opportunities, DJ's message to the listeners or the like. The signal may include only one of these features or a combination thereof. The signal enters a server 204, which serves as a gateway to the radio system, and the server 204 feeds the signal with the content item relating to the media stream to the network 206 of the radio system. A base station of the network, then, transmits the signal to the user equipment 110 in the coverage area of the network of the radio system 206 if the use of the parallel channel has been initiated in the user terminal 110.

The received content item is then presented in the user terminal 110 at a given moment in time that is determined based on the association of the content item with the broadcasting time line and on the synchronization of the internal time of the user terminal 110 with the internal time of the broadcast system 2000. The presented solution enables a synchronous presentation of the content items with the broadcast media stream time line in the user terminal 110. For example, when a song is played during the broadcast, then at the same time a content item associated to the song, such as the name of the song, is presented through the parallel channel in the user terminal 110 on a display, for example. Thus, a user may listen to a radio broadcast and at the same time follow the content item flow related to the same radio broadcast with the user terminal 110, for example.

In an embodiment of the invention, the user actively receiving the parallel channel has an opportunity to buy objects when object identification is shown to the user by the user equipment 110, the object identification being included in the content item. The object can be a text, a picture, a video, a widget, an audio recording, a game or a reference to download a game, a logo, a screen saver, a ringing tone, a multimedia presentation, a vibration/flashing/backlight/beeping tone sound of the user terminal, and a link to a video, a game, a screen saver, a ringing tone or a multimedia presentation, and a series of these or any combination thereof. The object identification may be shown to the user, for example, when a song being associated with the object starts playing on the broadcast. When the user wishes to receive or buy the offered object, the user initiates a delivery request by pushing the “deliver” or “buy” button displayed on the screen of the user equipment 110. It should be noted, however, that there is no need for the user to be able to receive or to be aware of the broadcast, but it is enough that the user can receive the object identification through the parallel channel.

The activation of the “buy” or “deliver” button forms a signal requesting to purchase or deliver the object, and the signal, including the object identification, is transmitted from the user equipment 110 to the base station of the network 206. In the network 206 the signal proceeds to an object provider's delivery system using the parameters attached to the object identification. If the object provider is an operator, the object may be in an object database, which may be a part of the network 206. The object provider can also be a maintainer of the server 204, which in such a case may include the object database. Additionally, the object provider may be the broadcaster, and hence, the object database can also be a part of the content creation tool 202.

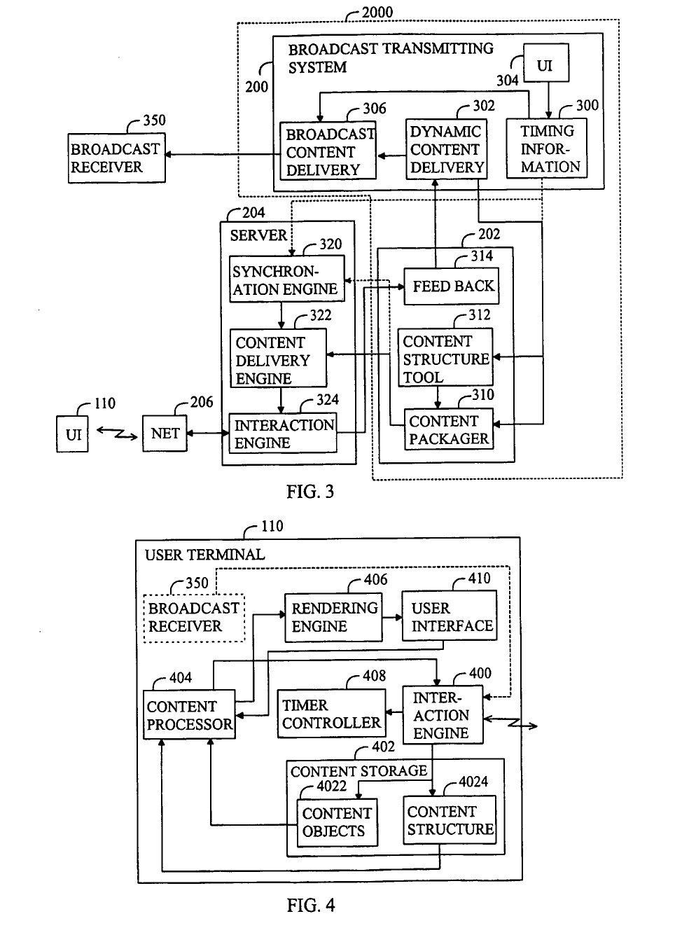

FIG. 3 shows more details of the broadcast transmitting system 200, the content creation tool 202 and the server 204. As already described in FIG. 2, along the parallel channel of the media system there may be the following elements: the broadcast transmitting system 200, the content creation tool 202, the server 204, the radio system 206 and the user terminal 110. The broadcast transmitting system 200 of a radio station uses a sophisticated digital content management system to run a broadcast, such as an FM transmission, an AM transmission or a digital radio or television transmission.

The Broadcasting System

The broadcast transmitting system 200 comprises a timing information module 300, a dynamic content delivery module 302, a broadcast content delivery module 306 and a user interface 304. Timing information on the broadcast to synchronize transmissions of the broadcast channel and the parallel channel is communicated to the server 204 by the timing information module 300. The timing information module 300 provides information on the starting time and the ending time of a particular program, as well as information on timing of advertising breaks or start and end times of a song etc. The length of advertising and other similar breaks can be deduced, for example, from the show run time at the starting time of the break.

The dynamic content delivery module 302 can feed additional content information to a content structure tool 312 and to a content packager 310 in the content creation tool 202 and finally to a content delivery engine 322 in the server 204. The additional content information from the dynamic content delivery module 302 can be, for example, results of events taking place in the broadcast, such as the name of the winner in a quiz show. When the additional content information is determined during the program, for example, in live events, sports coverage or in broadcast radio, the additional content information is communicated to the content packager 310 to create additional content items dynamically.

In addition, the dynamic content delivery module 302 can receive interaction results from an interaction engine 324 through a feedback module 314 of the content creation tool 202 to be used as a part of the broadcast, for example, to display the results of a vote on the TV as a video overlay.

The broadcasting personnel use the user interface 304 to control and adjust parallel channel timing with respect to the broadcast media stream. For example, the signalling in the parallel channel may be paused and resumed. These control events are communicated through a synchronization engine 320 of the server 204 to an interaction engine 400 of the user equipment 110, which interaction engine 400 adjusts parallel channel timing accordingly.

The broadcast content delivery module 306 performs the broadcast to a broadcast receiver 350, such as an FM radio receiver, a TV set receiver or the like. The receiver 350 may be included in the user equipment 110.

The feedback module 314 of the content creation tool 202 processes the interaction results and creates a suitable presentation to be shown to the broadcasting personnel or to the receivers of the broadcast.

Content Creation Tool

The content creation tool 202, which can also be called a visual radio tool in many applications, is used to create the parallel channel content presentation to be presented in the user equipment 110. The content creation tool 202 is located in a radio or in a television station and the content creation tool 202 can be integrated into the broadcast transmitting system 200. The content structure tool 312 defines timing to when the content item is to be displayed in a user terminal 110 in relation to a broadcast media stream time line (for example, show the content item on a screen of the user terminal at 14:43:02 after the beginning of the program). In addition, the content items are created and a user navigation structure within the parallel channel is defined by the content creation tool 202. The user navigation structure can define the deliverer, the price of the object etc. Responses that are sent to the server 204 in response to the user interaction can be fed to the feedback module 314 of the content creation tool 204.

The content structure tool 312 defines the layouts for displaying the content items and other content objects, such as their size and positions on the screen of the user terminal 110.

The content packager 310 is used to create a content package to be delivered to the user equipment 110 including the content structure definition created using the content structure tool 312 as well as the content item to be displayed, including text strings, graphic file objects, animations, video clips, etc. The packaging comprises linking the content items to the broadcast media stream in a way that the content item is associated to the broadcasting time line of the broadcast media stream. Also, the content packager 310 defines the availability of the content item in relation to the broadcasting time line of the broadcast media stream.

Generally, the content creation tool 202 allows the broadcaster to create a visual presentation and manage the content flow shown on the screen of the user terminal 110 in synchronization with the broadcast. In addition, the content creation tool 202 allows the broadcaster to manage interactive elements, such as delivering and purchasing objects, votings and quizzes.

Server

The server 204 provides the users with the content items related to the broadcast media stream based on their current parallel channel selection. The server 204 controls the content item flow to and from the user terminal 110. It facilitates the timed delivery of content to the user terminal as well as collecting and forwarding interaction results to the radio station. The server 204 controls the number of users. If necessary, the server 204 limits the number of users using the parallel channel at the same time. The server 204 also handles content adaptation for different application platforms in various user terminals.

The synchronization engine 320 receives the starting time and advertising break information from the content creation tool 202 or from the timing information module 300 of the broadcast transmitting system 200, for example. In addition, the synchronization engine 320 provides the means for the user terminal 110 for synchronizing its internal time to broadcast system time references by running a synchronization algorithm, for example.

The content delivery engine 322 delivers a signal with the content package created by the content packager 310. The signal is fed from the content delivery engine 322 to the interaction engine 324 of the server 204, which sends the signal through the radio system 206 to the user terminal 110. A user terminal specific variant of the content item can be delivered, which contains graphic objects optimised to the capabilities and the screen size of each user terminal. One content package, including object identifications or other content items, may correspond to the whole program and be delivered before the program starts. The content can alternatively be delivered in one package that contains both the user terminal software module in a suitable format, such as a Java MIDlet and the content package for a particular show. This is suitable for recorded shows and programs, where the content and the content timeline are known beforehand. In this case, dynamic content can be delivered in addition to the content package to take care of variation in the contents during broadcast. By delivering all or a part of the content beforehand the network traffic of the radio system 206 during the program reduces. The synchronization and the timing makes it possible to present the content timely.

Alternatively, the content can be delivered dynamically in content blocks, where a block corresponds to a segment of the program. This approach is suitable for, for example, FM radio where a play list is usually decided for several songs to be played and for advertising breaks.

Interaction Engine

The interaction engine 324 can forward delivery and purchase requests from the user terminals 110 to the provider's database actually delivering the requested object. It is also possible that the interaction engine 324 or some other part of the server 204 serves as a database, and also responds to the request and delivers the requested object. In addition, the interaction engine 324 of the server 204 collects the interaction responses from the user terminals 110 and makes them available to the broadcast transmitting system 200 as well as to the broadcast personnel for adaptation purposes, for instance. The interaction engine 324 may also create and store statistics of the number of users as well as of the activity to participate in interactions.

A billing unit may be connected to the radio system for managing billing transactions relating to the user's requests of objects and for generating invoices to the user terminals in accordance with the billing transactions. The transactions may be recorded so as to present invoices to the users of the media system.

User Terminal

FIG. 4 illustrates the user terminal 110, which may comprise conventional components, including wireless modems, processors, a memory, a user interface, a display, etc. In addition, the user terminal 110 may include a broadcast receiver 350, such as a TV or a radio tuner, a video streaming engine, etc.

The user terminal 110 includes a specific software module for creating the parallel channel experience. This module, which comprises blocks 400-410, can be implemented using a native operating system, such as Symbian, or a programming environment, such as Java MIDP.

The content item delivered to the user terminal 110 from the interaction engine 324 is stored in a local memory 402. The content structure is separated from content objects and screen layouts. The content structure refers to the layout, the structure and style of each slide, the slide referring to one screen of information presented in the user terminal 110 at a particular time. The content objects, which may be stored in a content objects module 4022 of the local memory 402, refer to texts and figures, for example. The content item can be represented as a template into which texts and signs can be added. The content can be stored into and separate from a content storage of the local memory 402 as a background process, so that the required information, such as object identification, is always available for a content processor 404 and a rendering engine 406 when needed. The rendering engine 406 forms the visual and acoustic effects of the content item for the user. Default information can also be stored in the content storage of the local memory 402 to be shown if dynamic contents cannot be delivered to the user terminal 110 on time.

The initiation of the parallel channel can be made in several ways. The user may select an operation, which makes the user terminal 110 receive and present the information of the parallel channel. If the user terminal 110 includes a receiver for the broadcast channel, the user can select a suitable broadcast channel and the user terminal 110 may automatically initiate the reception and presentation of the parallel channel instead of a manual initiation.

When the parallel channel software operation in the user terminal 110 is initiated, the user terminal 110 may transmit information about itself to the server 204, and the server 204 informs the user terminal 110 about the broadcast media stream. With the information about the user terminal 110 a specific variant of the contents can be delivered, which contains graphic objects optimised to the capabilities and the screen size of each user terminal 110.

When a timer controller module 408 is in connection with the server 204, the timer controller module 408 runs a synchronization algorithm to synchronize an internal clock of the user terminal 110 with the time of the server 204. A simple synchronization algorithm based on calculating round trip delays of requests sent to the server 204 from the user terminal 110 and calculating the difference between the user terminal clock and the server clock can be used. Once the user terminal 110 has performed synchronization and the starting time of a program is known, a broadcast media stream timeline references can be translated to references in the internal clock of the user terminal 110. The content items can be shown to the user in synchronization with the broadcast.

The timer controller 408 determines whether the program has already started and what the current time line position is. If the program is running, the timer controller 408 can automatically find a correct content item to be presented in the user interface 410.

Once the software of the user terminal 110 is activated and the user terminal 110 has received the content item to be shown at the current time, the content processor 404 starts to execute. The content processor 404 reads the content structure definition from a content structure memory 4024 to determine the current content to be displayed and communicates the content items and related layouts to the rendering engine 406 for presentation in the user interface 410. Based on the content structure definition, the content processor 404 informs the timer controller 408 to create timer events to trigger advancement in the parallel channel according to the content structure. When such a timer event takes place, the content processor 404 is again initiated to present the next content item. The processor 404 reads again the structure definition in the content structure memory 4024, determines the current content items and layouts and sends them to the user interface 410 to be presented.

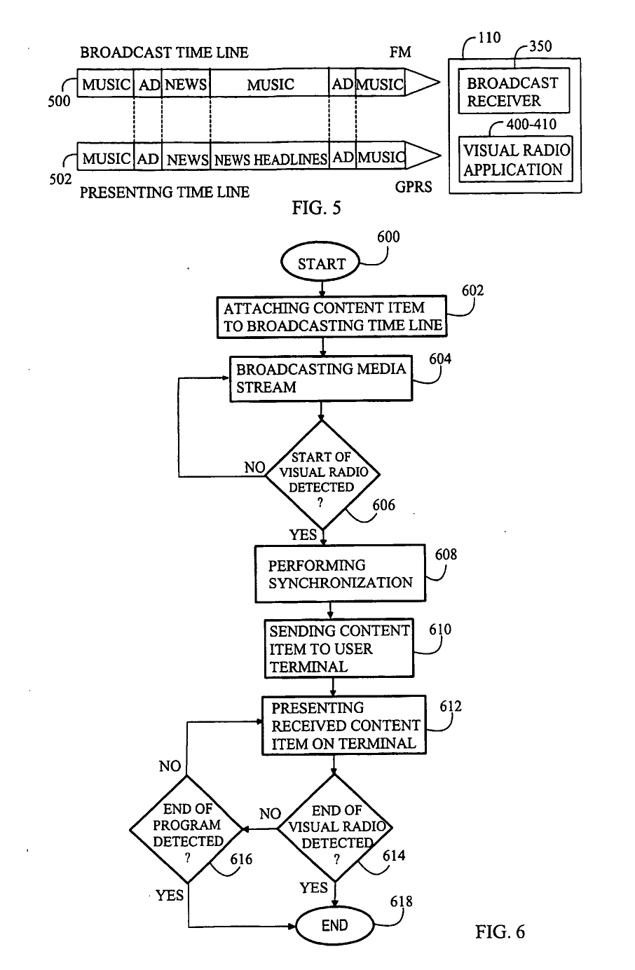

FIG. 5 shows an illustrative example of the time lines of the media system in relation to the user terminal 110. The upper time line represents the broadcast time line 500 and the lower time line represents the content item presenting time line 502. The user terminal 110 of FIG. 5 comprises a broadcast receiver 350 and a visual radio application 400-410 that comprises the parts 400 to 410 of FIG. 4, for example. It is also possible that the user terminal 110 does not comprise a broadcast receiver 350 at all. The broadcast receiver 350 is configured to receive the broadcast media stream, such as a radio program, and to play it on the user terminal 110. The visual radio application 400-410, in turn, enables the synchronized presentation of the content items associated with the broadcasting time line of the broadcast media stream.

The broadcast time line 500 is divided into parts of different lengths. The parts comprise parts of the broadcast media stream such as music, advertising and news, for example. FM transmission, for example, may be used in broadcasting the media stream to the broadcast receiver 350. The broadcast system is configured to associate content items to the broadcasting time line 500 of the broadcast media stream. The content items are related to the broadcast media stream in a synchronized fashion, that is, each content item is located in the presenting time line 502 at a specific moment in time. For example, when the broadcast time line 500 comprises a music part, the corresponding presenting time line 502 comprises content items relating to the music, such as the name of the musical piece played at the time. During a musical period in the broadcast time line 500, news headlines could also appear at the corresponding presenting time line 502 to be presented in the user terminal 110. During commercial breaks, content items comprising object identifications enabling the purchase of the advertised objects may be presented in the user terminal 110, for example.

FIG. 6 shows an example of the method of providing one or more content items to a user terminal of a radio system, the content item being related to a broadcast media stream. The method starts in 600. In 602, the content item is attached to a broadcasting time line of the broadcast media stream. The attachment of the content item is performed under the control of the broadcasting system in the content creation tool 202, for example. The attachment of the content item to the broadcast media stream may be based on defining the content item's availability to presentation prior, during and after the broadcast of the broadcast media stream. In 604, the broadcast media stream is broadcast by the broadcasting system, the broadcast media stream being a radio program transmission, for example.

In 606, it is detected in the user terminal whether the user of the terminal initiates the start of the visual radio application. Here, the visual radio application refers to the parallel channel service relating to the broadcast media stream. If the user terminal comprises a broadcast receiver, it is possible that turning on the broadcast receiver automatically initiates the start of the visual radio application as well. Thus, the user only has to select a broadcast channel of interest in order to initiate the visual radio application. The user terminal may show program guides of the broadcast stations. The user may glance through the contents of the program guides before selecting the broadcast channel or the program he wishes to receive, for example. It is possible that the program guides comprise information on which programs in a given broadcast channel are offering the parallel channel services, for example. Only by selecting such programs the visual radio application is initiated, for instance. Thus, the parameters relating to a given program are communicated to the server and the server automatically delivers the content item flow relating to the correct program to the user terminal. Also, the correct address for the server delivering the parallel channel may be found from the program guide. The program guide may comprise timing information of the programs as well. For example, estimates on the actual starting times of the programs may be found from the program guide. If the program's starting time is delayed, the user may be informed about the start of the program with an alarm, for example, and the visual radio application is then initiated. It is also possible to send such alarms that automatically initiate the parallel channel service to other user terminals or from a server to the user terminal over SMS (Short Message Service), MMS (Multimedia Messaging Service), WAP (Wireless Application Protocol) push message, or the like.

If in 606, the start of the visual radio application is detected, the process proceeds to 608, where an internal time of the user terminal is synchronized with the internal time of the broadcast system. It is possible that synchronizing data is first sent to the user terminal for synchronizing an internal time of the user terminal with the internal time of the broadcast system. The synchronizing data may be sent from the radio system or with the broadcast media stream from the broadcast system. An RDS system may be used for sending the synchronization data with the broadcast media stream. The synchronization may be performed also by executing a synchronization algorithm, for example. The synchronization algorithm may first cause signals to be sent from the user terminal to the radio system. Then round trip delays of the signals and the difference between the internal times of the user terminal and the radio system are calculated. Finally, the internal time of the user terminal is synchronized based on the calculated difference between the internal times, for example.

In 610, the content items attached to the broadcasting time line of the broadcast media stream are sent to the user terminal from the radio system. The content items may be sent before the program starts, during the program or after the program has already started. It is possible that some part of the content items is sent before the start of the program and other parts of the content items are sent during the program.

In 612, the received content items are presented in the user terminal, on the screen of the user terminal, for example. At the same time, the user may follow the program with the broadcast receiver as well. The received content items are presented in the user terminal at a given moment in time that is determined based on the attachment of the content item to the broadcasting time line and on the synchronization of the internal time of the user terminal with the internal time of the broadcast system. Thus, the user may follow the program through the broadcast receiver and at the same time receive additional information relating to the program with the visual radio application. It is not necessary, however, that the user terminal even comprises a broadcast receiver; the visual radio application may still be used to receive parallel channel content items from the radio system.

In 614, if the end of the visual radio is detected, the method proceeds to 618 where the visual radio application is no longer on. The user of the terminal may have turned off the visual radio application or the parallel channel service through the radio system may have ended. In 616, if it is detected that the selected program ends, then the process proceeds to 618, where the visual radio application is turned off. Thus, the visual radio application may automatically turn itself off, when the selected program ends.

Even though the invention is described above with reference to an example according to the accompanying drawings, it is clear that the invention is not restricted thereto but it can be modified in several ways within the scope of the appended claims.

1. A method of providing one or more content items to at least one user terminal of a radio system, the content item being related to a broadcast media stream, the method comprising:
attaching the content item to a broadcasting time line of the broadcast media stream by a broadcasting system;
broadcasting the broadcast media stream by a broadcasting system;
synchronizing an internal time of the user terminal with the internal time of the broadcasting system;
sending the content item attached to the broadcasting time line of the broadcast media stream from the radio system to the user terminal; and
presenting the received content item in the user terminal at a given moment in time that is determined based on the attachment of the content item to the broadcasting time line and on the synchronization of the internal time of the user terminal with the internal time of the broadcasting system.

2. The method of claim 1, further comprising sending synchronization data to the user terminal for synchronizing the internal time of the user terminal with the internal time of the broadcasting system and synchronizing the internal time of the user terminal based on the received synchronization data.

3. The method of claim 2, further comprising synchronizing the internal time of the radio system with the internal time of the broadcast system and sending the synchronization data from the radio system to the user terminal.

4. The method of claim 2, further comprising sending synchronization data with the broadcast media stream broadcasted by the broadcasting system to the user terminal.

5. The method of claim 4, further comprising using a Radio Data System (RDS) for sending the synchronization data from the broadcasting system.

6. The method of claim 1, wherein synchronization of the internal time of the user terminal with the internal time of the broadcasting system comprises executing a synchronization algorithm in the user terminal.

7. The method of claim 6, wherein executing the synchronization algorithm comprises:
sending signals from the user terminal to the radio system;
calculating round trip delays of said signals;
calculating the difference between the internal times of the user terminal and the radio system; and
synchronizing the internal time of the user terminal based on the calculated difference between the internal times.

8. The method of claim 1, wherein the content item comprises one or more of the following: a text, an audio, a video, an image, a multimedia presentation, and a series of these or any combination thereof.

9. The method of claim 1, wherein the content item comprises an object identification of an object and the method further comprising sending a transaction signal with the object identification from the user terminal to the radio system and delivering the object of the object identification to the user terminal through the radio system.

10. The method of claim 1, further comprising attaching the content item to the broadcast media stream by defining the content item's availability to the presentation prior, during and after the broadcast of the broadcast media stream.

11. A media system including a broadcasting system configured to broadcast a broadcast media stream, the media system comprising:
a radio system communicating with the broadcasting system and one or more user terminals,
the broadcasting system is further configured to attach one or more content items to a broadcasting time line of the broadcast media stream in the broadcasting system;
the user terminal is configured to synchronize an internal time of the user terminal with the internal time of the broadcasting system;
the radio system is configured to send the content item attached to the broadcasting time line of the broadcast media stream to the user terminal; and
the user terminal is further configured to present the received content item in the user terminal at a given moment in time that is determined based on the attachment of the content item to the broadcasting time line and on the synchronization of the internal time of the user terminal with the internal time of the broadcasting system.

12. The media system of claim 11, wherein the user terminal is configured to receive synchronization data and to synchronize its internal time with the internal time of the broadcasting system based on the received synchronization data.

13. The media system of claim 12, wherein the radio system is configured to synchronize its internal time with the internal time of the broadcasting system and to send the synchronization data to the user terminal.

14. The media system of claim 12, wherein the broadcasting system is configured to send the synchronization data to the user terminal with the broadcast media stream.

15. The media system of claim 14, wherein the broadcasting system is configured to use a Radio Data System (RDS) to send the synchronization data to the user terminal.

16. The media system of claim 11, wherein the user terminal is configured to synchronize the internal time of the user terminal by executing a synchronization algorithm.

17. The media system of claim 16, wherein the user terminal is configured to execute the synchronization algorithm by:
sending signals from said user terminal to the radio system;
calculating round trip delays of said signals;
calculating the difference between the internal times of the user terminal and the radio system; and
synchronizing the internal time of the user terminal based on the calculated difference between the internal times.

18. The media system of claim 11, wherein the content item is one or more of the following: a text, an audio, a video, an image, a multimedia presentation, and a series of these or any combination thereof.

19. The media system of claim 11, wherein the content item comprises an object identification of an object and the user terminal is further configured to send a transaction signal with the object identification from the user terminal to the radio system and the radio system is configured to deliver the object of the object identification to the user terminal.

20. The media system of claim 11, wherein the broadcasting system is configured to attach the content item to the broadcast media stream by defining the content item's availability to the presentation prior, during and after the broadcast of the broadcast media stream.

21. A user terminal of a radio system, wherein the user terminal is configured to:
synchronize the internal time of the user terminal with the internal time of a broadcasting system;
receive one or more content items through the radio system which content items are attached to a broadcast media stream of the broadcasting system; and
present the received content items attached to the broadcast media stream at a given moment in time that is determined based on the synchronization of the internal time of the user terminal with the internal time of the broadcasting system.

22. The user terminal of claim 21, wherein the user terminal is configured to receive synchronization data and to synchronize its internal time with the internal time of the broadcasting system based on the received synchronization data.

23. The user terminal of claim 22, wherein the user terminal is configured to receive the synchronization data from the radio system or from the broadcasting system.

24. The user terminal of claim 21, wherein the user terminal is configured to synchronize the internal time of the user terminal by executing a synchronization algorithm in the user terminal.

25. The user terminal of claim 24, wherein the user terminal is configured to execute the synchronization algorithm by:
sending signals to the radio system;
calculating round trip delays of the signals;
calculating the difference between the internal times of the user terminal and the radio system; and
synchronizing the internal time of the user terminal based on the calculated difference between the internal times.

26. The user terminal of claim 21, wherein the content item comprises an object identification of an object and the user terminal is configured to send a transaction signal with the object identification from the user terminal to the radio system and to receive objects of the object identification delivered from the radio system.
